(19) United States
(12) Patent Application Publication
(10) Pub. No.: US 2002/0093916 A1
(43) Pub. Date: Jul. 18, 2002

(54) Method for routing and interchanging messages in a telecommunications system, and associated telecommunications system

(76) Inventor: Marcel Vencour, Wien (AT)

Correspondence Address: BELL, BOYD & LLOYD, LLC, P. O. BOX 1135, CHICAGO, IL, 60690-1135, US

(21) Appl. No.: 10/017,559

(22) Filed: Dec. 13, 2001

(30) Foreign Application Priority Data
Dec. 14, 2000 (DE) 100 623 83.2

(51) Int. Cl. H04J 3/14; H04L 12/66

(52) U.S. Cl. 370/238; 370/352

(57) ABSTRACT

A method for interchanging and routing messages in a telecommunications system having at least one computer network and at least one switching-oriented network with at least one telecommunications terminal with a telephone number, which are connected to one another via a number of gateways which are set up for transmitting voice messages, with a gateway that is most cost-effective for voice transmission being associated with a name which is formed from parts of the telephone number which can be predetermined.

### BACKGROUND OF THE INVENTION

The present invention relates to a method for cost-effective routing and transmission of messages in a telecommunications system having a computer network and a switching-oriented network, which are connected to one another via a number of gateways which are set up for transmitting messages between the two networks, and each gateway having one address in both networks in accordance with the respective network-specific transmission protocol. The switching-oriented network has a number of telecommunications terminals, each of which has an associated telephone number, in which case the addresses of the gateways in the computer network can be assigned names which can be stored together with the associated address in at least one databank in the computer network.

The present invention likewise relates to a telecommunications system having a computer network and a switching-oriented network, which are connected to one another via a number of gateways which are set up for transmitting messages between the two networks, and each gateway having one address in both networks in accordance with the respective network-specific transmission protocol. The switching-oriented network has a number of telecommunications terminals, each of which has an associated telephone number, in which case the addresses of the gateways in the computer network can be assigned names which can be stored together with the associated address in at least one databank in the computer network.

Telephoning, that is to say voice transmission, via data networks, in particular the Internet, has been gaining increasing interest recently, particularly with regard to the low call charges in comparison to switching-oriented telephony.

The high level of user acceptance, widespread use of public switching-based telecommunications networks and the low charges that are incurred for voice transmission in data networks make it desirable to link these specific advantages of both networks and to use them jointly.

In this context, “Internet telephony” has developed recently. Numerous network operators, for example IDT, already offer solutions for combined transmission of messages via the Internet and public switching-oriented telecommunications networks.

One of the main problems of Internet telephony is, for cost reasons, for as much of the transmission path as possible to be traveled in the Internet before the message is passed on to a switching-oriented network; for example, the landline network. For this reason, the routing of a message and the finding of the most cost-effective gateway, that is to say that gateway from which the transmission path in the switching-oriented network to a telecommunications terminal in that network is the shortest, is gaining particularly major importance.

In this document, the word gateway refers the hardware and software which are required in order to connect a data network and a switching-oriented network to one another, and to connect them to one another by protocol conversion. The task of the gateway is to transmit messages from one network to the other network, for which purpose the primary requirement is to translate the respective communication protocols. The gateway can, thus, be regarded as a type of protocol converter. A computer that is used especially for this purpose is normally provided to form a gateway. The gateway conventionally resides in the lowest common layer of the two networks; for example, the layer 7 in the ISO reference model.

The gateway “understands” the protocols of both networks completely and is a network node which can be addressed both in the data network and in the switching-oriented telecommunications network.

The conversion of messages in the gateway can include the conversion and temporary storage of the data packets, packet confirmation and flow control, and matching of the transmission speed in the two networks.

Routing algorithms and methods, which are generally highly complex, are used to attempt to find the most suitable gateway, in terms of the transmission costs, taking account of the structures of the data network and of the switching-oriented network. In this document, the word routes refers to a path selection function for transmitting messages between a number of telecommunications terminals. The routing problem can be characterized by posing the question as to how the message traffic to be transported from a first telecommunications terminal to a second telecommunications terminal can be transported optimally using the resources of the telecommunications system.

One method of the type mentioned initially has become known from WO 97/14238. In this case, the aim is to interchange voice messages between the Internet and the public, switching-oriented telephone network, with a gateway being provided for converting voice data to a format that is suitable for further transmission in the data network or switching-oriented network. The known method has the disadvantage that a complex routing method, via routing servers, is required to find the optimum transmission path. The setting-up of further gateways is associated with a very high labor cost and time penalty, since the routing servers must be reconfigured for this purpose, so that a major disadvantage of the method becomes considerably more apparent.

A further routing method for finding a suitable gateway for transmitting messages via Internet telephony has become known from WO 99/14931. A central routing server is used to search for a suitable gateway, with the routing server selecting a gateway on the basis of caller preferences. However, to do this, the central routing server has to know all the gateways and their specific advantages and disadvantages, as well as the relationships between the gateways. Implementation of the described method, as it is described in WO 97/14238, is thus complex, and in this case as well, the setting-up of new gateways is associated with a high labor cost and time penalty since it is necessary to take into account the network hierarchy.

A major disadvantage of the known methods is that they are highly complex to implement and to maintain, which is an impediment to extension of the telecommunications system, in particular, and is associated with high costs.

One object of the present invention is, thus, to provide a way which can be implemented easily and which allows the transmission costs incurred for transmitting a message between a data network and a switching-oriented network to be kept as low as possible, while also offering the capability for simple extension of the telecommunications system.

### SUMMARY OF THE INVENTION

This object is achieved by a method of the type mentioned initially, in that telecommunications terminals, which can be predetermined in the switching-oriented network and whose telephone numbers have a part which can be predetermined that is identical, are directly associated with one gateway, whose address in the computer network is assigned a name formed from those parts of the telephone numbers which are common to these telecommunications terminals, and is stored in the databank. The messages are transmitted from a first telecommunications terminal, which is associated with the computer network, to one of the telecommunications terminals which can be predetermined in the switching-oriented network, via the gateway which is directly associated with this telecommunications terminal in the switching-oriented network, with the name of the gateway being checked by the first telecommunications terminal in order to find this gateway in the databank of the computer network.

This solution makes it easier to find that gateway which is suitable for the most cost-effective transmission of the message, since the gateway can be identified easily. There is no longer any need for complicated routing algorithms for finding this gateway since the optimum gateway is known just from knowledge of the telephone number of a telecommunications terminal in the switching-oriented network.

In one preferred embodiment of the present invention, the computer network is the Internet, and the gateway has an associated domain name.

One embodiment of the present invention, which has been proven in practice, provides a number of gateways whose names match at least parts of the telephone numbers of telecommunications terminals which can be predetermined, with the messages being interchanged between the first telecommunications terminal, which is associated with the computer network, and the second telecommunications terminal which is associated with the switching-oriented network, via that gateway whose name provides the best match with the telephone number of the second telecommunications terminal.

In another embodiment of the present invention, a number of gateways are provided, which are organized hierarchically and whose names match at least parts of the telephone numbers of telecommunications terminals which can be predetermined, with each gateway knowing the gateways which are immediately subordinate to it.

In this case, a gateway finds out whether a gateway exists which is subordinate to it and whose domain name matches parts of the telephone number, which can be predetermined, with that gateway which has no further gateway subordinate to it on the basis of the telephone number and representing the lowest in the hierarchy.

Messages are interchanged between the first telecommunications terminal, which is associated with the computer network, and the second telecommunications terminal, which is associated with the switching-oriented network via that gateway which is the lowest in the hierarchy.

A telecommunications system of the type mentioned initially is particularly suitable for implementation of the method according to the present invention, in which telecommunications terminals, which can be predetermined in the switching-oriented network and whose telephone numbers have a part which can be predetermined that is identical, are directly associated with one gateway, whose address in the computer network is assigned a name formed from those parts of the telephone numbers which are common to these telecommunications terminals, and is stored in the databank. The telecommunications system is set up such that the messages are transmitted from a first telecommunications terminal, which is associated with the computer network, to one of the telecommunications terminals which can be predetermined in the switching-oriented network, via the gateway which is directly associated with them, with the first telecommunications terminal being set up to check the databank in the computer network in order to find this gateway in the computer network (WWW).

The computer network is preferably the Internet, and the gateway has an associated domain name.

One preferred embodiment of the present invention provides for a number of gateways whose names match at least parts of the telephone numbers of telecommunications terminals which can be predetermined, with the telecommunications system being set up to transmit messages from the first telecommunications terminal, which is associated with the computer network, to a second communications terminal which is associated with the switching-oriented network, via that gateway whose name provides the best match with the telephone number of the second telecommunications terminal.

One advantageous embodiment of the present invention provides for the telecommunications system to be set up to interchange messages between the first telecommunications terminal and the second telecommunications terminal via that gateway whose name provides the best match with the telephone number of the second telecommunications terminal.

Another embodiment of the present invention provides for a number of hierarchically organized gateways to be provided, whose names match at least parts of the telephone numbers of telecommunications terminals which can be predetermined, with each gateway knowing the gateways which are immediately subordinate to it.

In this case, a gateway is set up to find out whether a gateway exists which is subordinate to it and whose name matches parts of the telephone number which can be predetermined, with that gateway which has no further gateway subordinate to it on the basis of the telephone number representing the lowest in the hierarchy.

Furthermore, the telecommunications system is set up to interchange messages between the first telecommunications terminal, which is associated with the computer network, and the second telecommunications terminal, which is associated with the switching-oriented network, via the lowest gateway in the hierarchy.

Additional features and advantages of the present invention are described in, and will be apparent from, the following Detailed Description of the Invention and the Figures.

### BRIEF DESCRIPTION OF THE FIGURES

FIG. 1 shows a first embodiment of a telecommunications system according to the teachings of the present invention.

FIG. 2 shows a second embodiment of a telecommunications system according to the present invention.

### DETAILED DESCRIPTION OF THE INVENTION

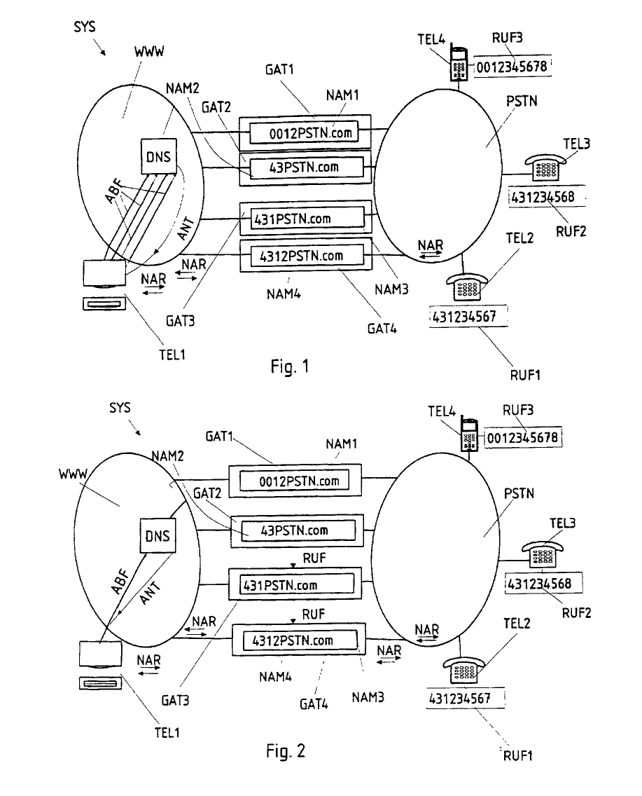

As shown in FIG. 1, a telecommunications system SYS according to the present invention has a computer network WWW, preferably the Internet, and a switching-oriented telecommunications network PSTN, preferably the public telephone network.

The two networks, WWW, PSTN, are connected to one another via a number of gateways GAT1-GAT4 which are set up to allow data to be interchanged, in particular for voice messages NAR to be interchanged, between the two networks WWW, PSTN.

The following text refers, in particular, to the transmission of voice messages between the two networks WWW, PSTN, although the transmission of messages that are in some other form, for example in the form of text messages, is carried out on the basis of the same criteria with regard to the selection of the gateways.

Both the computer network WWW and the switching-oriented network PSTN have network-specific telecommunications terminals TEL1-TEL4. For the Internet, these may be, for example, H.323 or SIP terminals, such as personal computers. For the public PSTN network, they may be PSTN terminals with a telephone number, for example a mobile radio telephone TEL4 or a landline telephone TEL2, TEL3.

In order to input and transmit a voice message NAR from the computer network WWW, the telecommunications terminal TEL1 associated with this network must have a voice input, for example a microphone, and a voice processing apparatus which converts the voice signals to a format that is suitable for transmission in the computer network WWW. The conversion of the data to a format that is suitable for the switching-oriented network PSTN is carried out by one of the gateways GAT1-GAT4.

Methods and apparatuses for conversion of voice messages NAR and protocols for transmission of voice messages NAR via a computer network WWW and a switching-oriented network PSTN are known to those skilled in the art, and therefore will not be discussed any further at this point. One such protocol is, for example, the “Voice over IP” protocol for the Internet. A method for transmitting voice data from the Internet to a mobile radio telephone has also become known from EP 0 883 313.

The method according to the present invention for finding the most suitable gateway GAT1-GAT4, that is to say if the telecommunications terminal TEL2, TEL3, TEL4 being called is a landline telephone in the switching-oriented network PSTN, that gateway GAT1-GAT4 which is geographically/physically the closest to the second telecommunications terminal TEL2-TEL4 provides for this gateway GAT1-GAT4 to be given a name NAM1-NAM4, which contains parts of the telephone number RUF1-RUF3 of the second telecommunications terminal TEL2-TEL4.

A gateway GAT1-GAT4 also may be associated with each of a number of groups of telecommunications terminals TEL2-TEL4 in the PSTN network. As already mentioned above, a gateway GAT1-GAT4 may be allocated on a geographical basis, that is to say a gateway GAT1-GAT4 is allocated to the telecommunications terminals TEL2-TEL4 in a regional or local zone, with this gateway GAT1-GAT4 being located in this zone, or representing the gateway GAT1-GAT4 which is the closest to this zone. This allows the transmission path between the gateway GAT1-GAT4 and the telecommunications terminal TEL2-TEL4 in the switching-oriented network PSTN, whose transmission costs are more expensive, to be considerably shortened. In this way, the charges which are incurred for voice transmission from the computer network WWW to the switching-oriented network PSTN depend mainly on the call duration and no longer on the length of the overall transmission path between the telecommunications terminals TEL1, TEL2-TEL4 that are involved.

Another way to allocate the gateway GAT1-GAT4 to the telecommunications terminal TEL2-TEL4 in the PSTN network is not based on the geographical/physical proximity to the telecommunications terminal TEL2-TEL4, although this is particularly important for mobile telephones TEL3, and can be carried out by allocating a gateway GAT1 to a mobile radio network operator for the switching-oriented network whose name is derived from the dialing code of the relevant mobile radio operator.

The names NAM1-NAM4 and the addresses of the gateways GAT1-GAT4 in the computer network WWW are stored in one or more databanks DNS in the computer network.

If the computer network WWW is the Internet, then, in order to make it possible to find the most cost-effective gateways GAT1-GAT4 without complex search algorithms, the gateways GAT1-GAT4 are given domain names NAM1-NAM4 which include parts of the telephone number RUF2-RUF3. Owing to the syntax, a domain name NAM1-NAM4 includes a sequence of character groups which are separated from one another by dots; for example, 43PSTN.com. If, as already mentioned above, they are associated with a landline network terminal TEL2, TEL3, the names NAM1-NAM4 of the gateways GAT1-GAT4 may, in this case, reflect the geographical position of the gateways GAT2-GAT4 or, in the case of a mobile radio gateway GAT1, may reflect the respective association with a specific mobile radio network. In this way, a gateway GAT2-GAT4 which is located in Austria may have the name 43.PSTN.com, while a gateway which is located in Germany may be called, for example, 49.PSTN.com. Further gateways GAT1-GAT4 may be provided in the national telephone zones at the national level. A gateway GAT3 for Vienna may have the name NAM3 431.PSTN.com, and a gateway for a district of Vienna may have the name 4315.PSTN.com.

The longer the name NAM1-NAM4 of the gateway GAT1-GAT4, the lower is its level in the corresponding switching hierarchy of the switching-oriented network PSTN. As such, for example, the first two digits of the name NAM1-NAM4 of a gateway may correspond to a central exchange, the third digit may correspond to a main exchange, and the fourth digit may correspond to a local exchange. The location of a gateway GAT1-GAT4 can be established uniquely by name assignment in the manner just described.

In order to set up a connection between a first telecommunications terminal TEL1, which is associated with the Internet, and a second telecommunications terminal TEL2-TEL4, which is associated with the switching-oriented network, the telephone number of the second telecommunications terminal TEL2-TEL4 may be entered via the first telecommunications terminal TEL1. The first telecommunications terminal TEL1 then uses the telephone number RUF1-RUF3 which has been entered to transmit checking messages ABF to a databank DNS, for example the domain name system, in order to find out whether there is a gateway GAT1-GAT4 whose name at least partially matches this telephone number RUF1-RUF3. If such a gateway is found, the telecommunications terminal TEL1 associated with the Internet receives a response ANT from the databank DNS.

If, for example, it is intended to call the telephone number “4311234567”, then the first telecommunications terminal TEL1 uses the digits of the entered telephone number RUF1-RUF3 to form domain names; for example, 4.PSTN.com, 43.PSTN.com, 431.PSTN.com, 4312.PSTN.com, . . . and 4311234567.PSTN.com. Then, by selecting these domain names, the domain name system uses the domain names that have been formed to check whether a gateway GAT1-GAT4 with one of these names NAM1-NAM4 exists.

If there are a number of gateways with one of the domain names just mentioned, then that gateway GAT1-GAT4 whose name NAM1-NAM4 is the longest is selected from these gateways GAT1-GAT4; for example, by the first telecommunications terminal TEL1. The first telecommunications terminal TEL1 sends to the selected gateway GAT1-GAT4 a confirmation message, which may contain that part of the telephone number RUF1-RUF3 which is not part of the name of that gateway. The confirmation message tells the gateway GAT1-GAT4 that it should select the telephone number RUF1-RUF3 that is also transmitted. The selection of the telephone number RUF1-RUF3 by the gateway GAT1-GAT4 and the setting up of the connection from the gateway GAT1-GAT4 to the telecommunications terminal TEL2-TEL4 in the switching-oriented network PSTN is carried out via methods known to those skilled in the art. One such method has become known, for example, from the initially cited WO 97/14238.

The method according to the present invention makes it possible for the gateway GAT1-GAT4 which is directly associated with a telecommunications terminal TEL2-TEL4 in the switching-oriented network PSTN, that is the gateway GAT1-GAT4 located geographically closest to this terminal if the telecommunications terminal TEL2-TEL4 which is associated with the switching-oriented network PSTN is a landline network terminal to be used to transmit the voice message NAR.

In order to keep the search for the most cost-effective gateway GAT1-GAT4 as short as possible, the first telecommunications terminal TEL1, which is associated with the computer network WWW, sends checking messages ABF parallel to the databank DNS. Since telephone numbers are subject to an international restriction to 15 digits including the national code, a maximum of 15 parallel checking messages ABF are produced and sent by the first telecommunications terminal.

Since it is possible for there to be no gateway GAT1-GAT4 for each of the names NAM1-NAM4 formed in accordance with the method described above, it is necessary to restrict the time for selection of the most suitable gateway GAT1-GAT4. That is, once a time period which can be predetermined has elapsed, the gateway GAT1-GAT4 with the longest name NAM1-NAM4 is selected from those gateways GAT1-GAT4 which actually exist or those which have been found.

What has been stated above also applies, of course, if the telecommunications terminal TEL2-TEL4 which is associated with the switching-oriented network is a mobile radio telephone TEL4. The only difference from what has been said above is that the most suitable gateway GAT1 is no longer the physically closest telecommunications terminal TEL4 which is associated with the switching-oriented network PSTN, but that which represents the optimum gateway GAT1-GAT4, and is allocated to a mobile radio network operator, just on the basis of the transmission costs. This will be illustrated in the following text with reference to an example.

A first subscriber wishes to make a call from the telecommunications terminal TEL1 using the Internet to a telecommunications terminal TEL4, which is associated with the switching-oriented network (a mobile radio telephone) of a second subscriber. The gateway GAT1 associated with the corresponding mobile radio network operator is determined using the method described above. If the gateway GAT1 is available to the mobile radio network operator, then it can be regarded as part of this mobile radio network operator's mobile radio network, and the call charges incurred correspond to the charges within this mobile radio network. Since the call charges within a mobile radio network are generally independent of the transmission distance within a national zone inside a mobile radio network, the transmission costs can be minimized in this way. Expensive network interfaces, such as those which may be possible when dialing a gateway GAT1-GAT4 (the gateway GAT1-GATA4 which is dialed or is found could actually be associated with a different network operator) can be avoided in this way.

A major advantage of the embodiment of the present invention described above is that the number of available gateways GAT1-GAT4 can be increased in a simple manner. A new gateway can easily be set up in the telecommunications system SYS without any need to consider existing network hierarchies. When setting up a new gateway, this gateway is simply given a name in accordance with the scheme described above, and this gateway is placed in the telecommunications system SYS. In this embodiment of the present invention, there is no need for the gateways GAT1-GAT4 to be connected to one another or to have any knowledge of one another. The time and costs involved for the implementation of new gateways GAT1-GAT4 are thus reduced to a minimum.

As shown in FIG. 2, the gateways GAT1-GAT4 are organized hierarchically in a second embodiment of the present invention. In this case, a checking message ABF for finding the most suitable gateway GAT1-GAT4 is generated by the first telecommunications terminal from the telephone number RUF1-RUF3 of a second telecommunications terminal TEL2-TEL4, which is associated with the switching-oriented network PSTN, and is sent to the databank DNS. This gateway GAT1-GAT4 represents the highest-level gateway GAT1-GAT4 in the transmission hierarchy between the first and the second telecommunications terminals TEL1-TEL4. The gateways GAT1-GAT4 represent nodes in the transmission hierarchy, with each gateway GAT1-GAT4 (each node) knowing the gateways GAT1-GAT4 which are subordinate to it and are one level below it. The names NAM1-NAM2 of the subordinate gateways GAT1-GAT4 are stored, for example in lists, in the respective higher-level gateway GAT1-GAT4.

If the computer network is the Internet, the first telecommunications terminal TEL1 uses the telephone number RUF1-RUF3 of the second telecommunications terminal TEL2-TEL4 to produce a checking message ABF, which includes a domain name NAM1-NAM4, which is formed from the first digit of the telephone number RUF1-RUF3, in accordance with the method described above.

The telephone number RUF1-RUF3 of the second telecommunications terminal TEL2-TEL4, for example minus the first digit, which is actually part of the name NAM1-NAM4 of the first gateway GAT1-GAT4 and is thus no longer required for finding further gateways GAT1-GAT4, is transmitted to the gateway GAT1-GAT4 corresponding to these domain names NAM1-NAM4.

The next digit of the telephone number RUF1-RUF3 allows the gateway GAT1-GAT4 to form the domain names NAM1-NAM4 of a gateway GAT1-GAT4 which is subordinate to it, and to compare these names NAM1-NAM4 with the names of the gateways GAT1-GAT4 stored in its list. If there is a subordinate gateway GAT1-GAT4 with this name NAM1-NAM4, then the telephone number RUF1-RUF3, or a reduced telephone number RUF1-RUF3, is passed on to this gateway GAT1-GAT4, which itself once again derives a domain name for a gateway GAT1-GAT4 that is subordinate to it, in accordance with the scheme mentioned above, from the telephone number RUF1-RUF3, and uses its list to compare whether any gateway GAT1-GAT4 with this name NAM1-NAM4 exists. If a gateway GAT1-GAT4 is finally obtained whose list does not contain any name NAM1-NAM4, which is applicable to the telephone number RUF1-RUF3 or to the reduced telephone number of the second telecommunications terminal TEL2-TEL4, for a gateway GAT1-GAT4 which is subordinate to it, then this gateway GAT1-GAT4 is identified as the most suitable for voice transmission to the second telecommunications terminal TEL2-TEL4. This gateway GAT1-GAT4 transmits a message to the first telecommunications terminal TEL1 to the effect that it is the sought gateway GAT1-GAT4; that is, the gateway directly associated with the second telecommunications terminal. Voice messages NAR are then transmitted from the first telecommunications terminal TEL1 to the second telecommunications terminal TEL2-TEL4 as in the first embodiment of the present invention, via this gateway GAT1-GAT4.

In this embodiment of the present invention, there is no need to restrict the time of the search for the most suitable gateway GAT1-GAT4 since the search ends automatically at the sought gateway GAT1-GAT4.

Although the present invention has been described with reference to specific embodiments, those of skill in the art will recognize that changes may be made thereto without departing from the spirit and scope of the invention as set forth in the hereafter appended claims.

1. A method for cost-effective routing and transmission of messages in a telecommunications system having both a computer network and a switching-oriented network, the method comprising the steps of:
connecting the computer network to the switching-oriented network via a plurality of gateways which are set up for transmitting messages between the computer network and the switching-oriented network;
providing each of the gateways with one address in both networks in accordance with a respective network-specific transmission protocol;
providing the switching-oriented network with a plurality of telecommunications terminals, each telecommunication terminal having an associated telephone number;
assigning names to the addresses of the gateways in the computer network which can be stored together with the associated address in at least one data bank in the computer network;
associating the telecommunications terminals, which can be predetermined in the switching-oriented network and whose telephone numbers have parts which can be predetermined that are identical, directly with one of the gateways whose address and the computer network is assigned a name formed from the parts of the telephone numbers which are common to the predetermined telecommunications terminals; and
transmitting the messages from a first telecommunications terminal, which is associated with the computer network, to one of the telecommunications terminals which can be predetermined in the switching-oriented network, via the gateway which is directly associated with the predetermined telecommunications terminal in the switching-oriented network, the name of the gateway being checked by the first telecommunications terminal in order to find the gateway in the data bank of the computer network.

2. A method for cost-effective routing and transmission of messages in a telecommunications system as claimed in claim 1, wherein the computer network is the Internet, and the gateways have associated domain names.

3. A method for cost-effective routing and transmission of messages in a telecommunications system as claimed in claim 1, wherein the messages are transmitted between the first telecommunications terminal and the second telecommunications terminal via the gateway, whose name provides a best match with the telephone number of the second telecommunications terminal.

4. A method for cost-effective routing and transmission of messages in a telecommunications system as claimed in claim 1, wherein the plurality of gateways are organized hierarchically, with each of the gateways knowing which of the gateways are immediately subordinate to it.

5. A method for cost-effective routing and transmission of messages in a telecommunications system as claimed in claim 4, wherein the gateways are set up to find out whether a gateway exists which is subordinate to it and whose name matches parts of the telephone number which can predetermined, with the gateway having no further gateway subordinate to it, based on the telephone number, representing a lowest gateway in the hierarchy.

6. A method for cost-effective routing and transmission of messages in a telecommunications system as claimed in claim 4, wherein the messages are transmitted between the first telecommunications terminal and the second telecommunications terminal via the gateway which is a lowest gateway in the hierarchy.

7. A telecommunication system for cost-effective routing and transmission of messages therein, comprising:
a computer network;
a switching-oriented network;
a plurality of telecommunications terminals associated with the switching-oriented network, each of the telecommunications terminals having an associated telephone number; and
a plurality of gateways for connecting and transmitting messages between the computer network and the switch-oriented network, each gateway having one address in both networks in accordance with a respective network-specific transmission protocol; and
wherein the addresses of the gateways in the computer network can be assigned names which can be stored together with the associated address in at least one data bank in the computer network, such that the telecommunications terminals, which can be predetermined in the switching-oriented network and whose telephone numbers have parts which can be predetermined that are identical, are directly associated with one of the gateways whose address in the computer network is assigned a name formed from the parts of the telephone numbers which are common to the predetermined telecommunications terminals, and the messages are transmitted from a first telecommunications terminal, which is associated with a computer network, to one of the telecommunications terminals which can be predetermined in the switching-oriented network, via the gateway which is directly associated with the predetermined telecommunications terminal in the switching-oriented network, with the first telecommunications terminal being set up to check the data bank in the computer network in order to find the gateway in the computer network.

8. A telecommunications system for cost-effective routing and transmission of messages therein as claimed in claim 7, wherein the computer network is the Internet, and the gateways have associated domain names.

9. A telecommunications system for cost-effective routing and transmission of messages therein as claimed in claim 7, wherein the messages are transmitted between the first telecommunications terminal and the second telecommunications terminal via the gateway whose name provides a best match with the telephone number of the second telecommunications terminal.

10. A telecommunications system for cost-effective routing and transmission of messages therein as claimed in claim 7, wherein the plurality of gateways are organized hierarchically, with each of the gateways knowing which of the gateways are immediately subordinate to it.

11. A telecommunications system for cost-effective routing and transmission of messages therein as claimed in claim 10, wherein the gateways are set up to find out whether a gateway exists which is subordinate to it and whose name matches parts of the telephone number which can be predetermined, with the gateway having no further gateway subordinate to it, based on the telephone number, representing a lowest gateway in the hierarchy.

12. A telecommunication system for cost-effective routing and transmission of messages therein as claimed in claim 11, wherein the messages are transmitted between the first telecommunications terminal and the second telecommunications terminal via the gateway which is a lowest gateway in the hierarchy.
